(19) United States
(12) Patent Application Publication
(10) Pub. No.: US 2012/0330808 A1
(43) Pub. Date: Dec. 27, 2012

(54) EVENT-DRIVEN FINANCIAL TRADING METHOD AND SYSTEM

(76) Inventor: Justin Bouchard, Chicago, IL (US)

(21) Appl. No.: 13/167,018

(22) Filed: Jun. 23, 2011

(51) Int. Cl. G06Q 40/00

(52) U.S. Cl. 705/37

(57) ABSTRACT

A system for creating event-driven financial transactions, which may include a data parser configured to receive large amounts of data from one or more sources pertaining to various indicators, such as economic indicators, a graphical user interface for receiving inputs from a user to build a transaction factoring in the value or change in value of a selected indicator, and a strategy engine for evaluating the transaction to determine whether to attempt to fill the order or take no action. The system may be used to create both standard and limit orders, and it may include a user-modifiable gradient display to allow the user to evaluate the relative likelihood of a proposed limit order.

### BACKGROUND OF THE INVENTION

1. Field of the Invention

The present invention is directed generally to the field of financial trading.

2. Description of the Related Art

Stocks, bonds, mutual funds, commodities, contracts, and other financial products are traded continuously in markets around the world. It is impossible to predict all the factors that may affect the price of these contracts, particularly as there is a wealth and, some might say, an overload of information available to consider. That being said, large institutional investors have sought to correlate the price of products with one or more indicators in an attempt to predict how those prices will react to changes in the indicators. These institutional investors have access to vast databases of information and armies of analysts working to build correlations. As of yet, however, it is believed that no similar product exists for the average investor.

Therefore, there exists a need for a method and system for event-driven financial trading that can provide smaller entities with the ability to analyze a plurality of potential indicators and schedule transactions based on updates to those indicators.

### SUMMARY OF THE INVENTION

In one aspect, a computer-implemented method for creating event-driven financial transactions may include the steps of: prompting a user to select an indicator from among a plurality of possible indicators; receiving an indicator selection; receiving a comparative function relating to an estimated value of the selected indicator; prompting the user to select an item to be traded from among a plurality of possible items; receiving an item selection; receiving inputs relating to price and volume variables for the selected item; generating a pending transaction, and displaying the pending transaction to the user in a form readable by the user. User selections may be received from a plurality of sources, including from an Internet website.

Additionally, the displaying step may include the steps of building the pending transaction progressively as more elements of the transaction are received, and displaying the pending transaction as it is built, e.g., in the form of a textual summary. The method also may include displaying historical information relating to the selected indicator. Moreover, the method may include the steps of receiving an updated value for the selected indicator, cross-checking the updated value with the comparative function to determine whether to execute the transaction, and transmitting an executed transaction to an exchange to be filled, where transmitting may include sending the executed transaction to a third party or directly to the exchange.

If the transaction is a sale, the method also may include the steps of cross-checking a user's inventory of the item against the volume variables and verifying that the user possesses a sufficient quantity of the item. Alternatively, the user may allow selected users to schedule short sale transactions.

In another aspect, a computer implemented method for creating and executing event-driven financial transactions may include the steps of: receiving information from at least one source pertaining to a plurality of indicators; converting the information into a form displayable to a user; receiving input variables from the user; generating a pending transaction; receiving updated information pertaining to a selected indicator; evaluating the pending transaction in view of the updated information; and transmitting the pending transaction to be filled if all of the input variables are met. The method also may include the steps of compiling a plurality of pending transactions in a single location viewable by the user, and displaying historical information relating at least one of an indicator and an item to be traded.

Historical information may be presented to the user in graphical form, wherein the graphical presentation of historical information provides for selections by the user. The step of receiving input variables may include receiving the user selections.

In addition, the method may include the step of providing a gradient display to the user, the gradient display comprising incremental information pertaining to the input variables. The gradient display may perform a variety of functions. For example, it may provide substantially real-time analysis of a number of available units of a selected item. It also may provide information relating to both purchase and sale transactions.

As such, the method may include populating fields within the gradient display with input variables, where the input variables are received via manual input or via selection from a graphical display. Additionally, one of said input variables may be an input deviation from an expected value of the selected indicator. The gradient display may include fields populated by deviations from the expected value, and the input deviation may include an upper or lower bound for the fields.

These and other features and advantages are evident from the following description, with reference to the accompanying drawings.

### BRIEF DESCRIPTION OF THE SEVERAL VIEWS OF THE DRAWINGS

FIG. 1 is a screenshot of one embodiment of a graphical user interface (GUI) for creating an event-driven financial transaction.

FIG. 2 is a screenshot of the GUI of FIG. 1 in which the user can select from among a plurality of indicators and can review historical data pertaining to the indicator.

FIG. 3 is a screenshot of the GUI of FIG. 1 in which the user can input logical constraints relating to a selected indicator.

FIG. 4 is a screenshot of the GUI of FIG. 1 in which the user can select the product to be traded and can review historical data pertaining to that product.

FIG. 5 is a screenshot of the GUI of FIG. 1 in which the user can input price and quantity values for the product to be traded.

FIG. 6 is a screenshot of the GUI of FIG. 1 combining the input fields of at least some of FIGS. 2-5 into one display.

FIG. 7 is a screenshot of the GUI of FIG. 1, displaying a strategy book of each of the user's pending transactions.

FIG. 8 is a screenshot of the GUI of FIG. 1, displaying the user's portfolio along with additional information about a selected product that is part of the portfolio.

FIGS. 9-12 are screenshots of a second embodiment of a GUI for creating an event-driven financial transaction.

FIG. 13 is a screenshot of a gradient display that may be integrated with the GUIs of FIGS. 1 and 9 to allow the user to evaluate and place limit orders.

### DETAILED DESCRIPTION OF THE INVENTION

As described herein, an event-driven financial trading system and method may enable a user to schedule and make one or more trades based on a chosen criterion or set of criteria.

The system may import indicator data from one or more sources, which may include manual entry or database lookups, but preferably may come from news feeds such as DOW JONES or REUTERS. Additionally or alternatively, data may be obtained from sources such as SELERITY DATA. These data feeds typically are not offered to retail investors but are presented to commercial investors on a subscription basis. System 10 may include a data parser 6 that receives this information and converts it into code readable by strategy engine 8. This code may include, among other things, an identifier for one or more input factors or indicators, a previous value for the indicator, an estimated value for the indicator, and at times, a current, updated, or new value for the indicator. Data may be transmitted in various formats, including binary and/or text formats, e.g., ASCII or EBCDIC. System 10 may include separate parsers for each format of code received from each data provider, although these separate parsers may be referred to collectively as a single data parser 6. Preferably, data is transmitted in a format compatible with FIX FAST protocol or in any similar format that allows for substantial compression of the data, which may be beneficial due to the high volume of data that may be received by data parser 6.

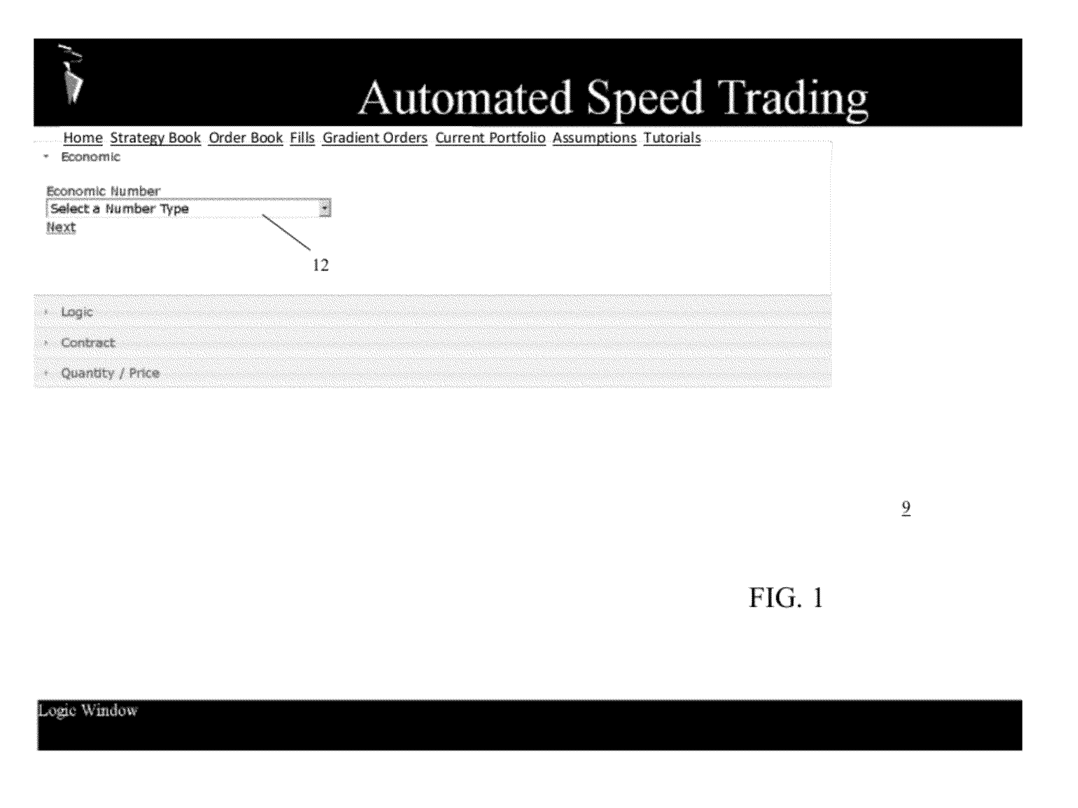

As seen in FIG. 1, strategy engine 8 may include a graphical user interface 9 that receives various inputs from the user. For example, interface 9 may prompt the user to select a reference data category, which may include providing the user with a list 12 comprising a plurality of categories and allowing the user to choose the selected category 14 from the list 12. Imported data may include indicator data such as GNP or GDP values (advance, preliminary, and/or final) for any country, consumer or producer price indices, unemployment rates, jobless claims, average hourly earnings, or any other value that may be considered an economic indicator. Additionally, data may include non-economic indicators, such as rainfall amounts for a given area, daily, weekly or monthly high temperatures or average temperatures, etc.

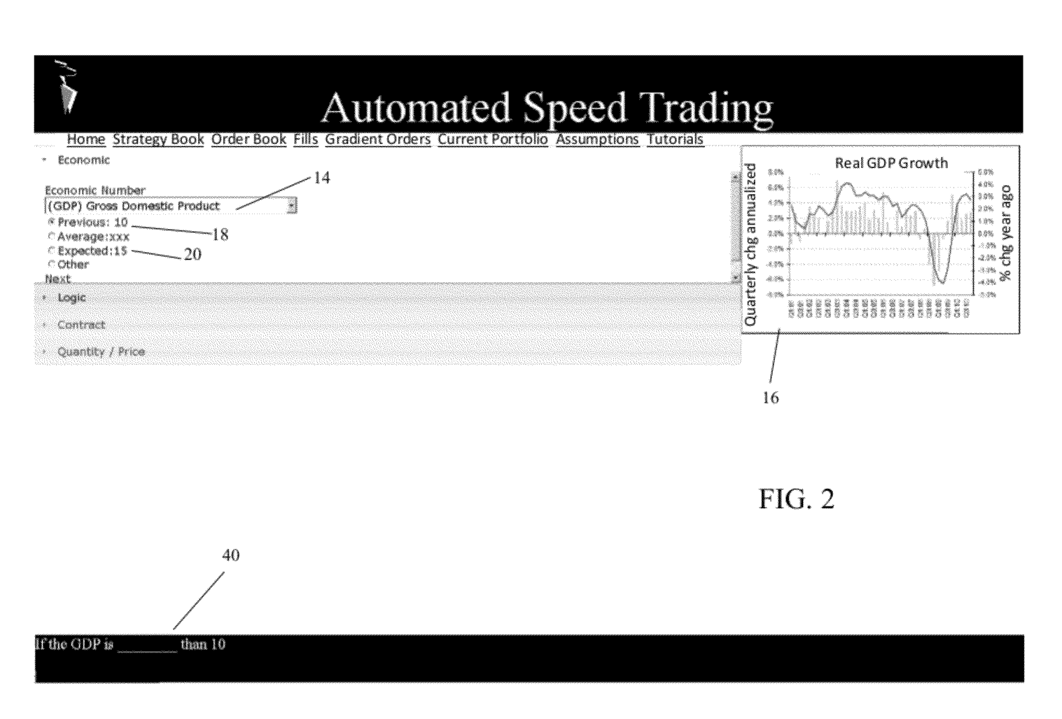

Historical data 16 for the selected indicator may be displayed on the same screen as this selection option, as seen in FIG. 2, which may provide the user with a visual indicator of historical patterns, trends, etc.

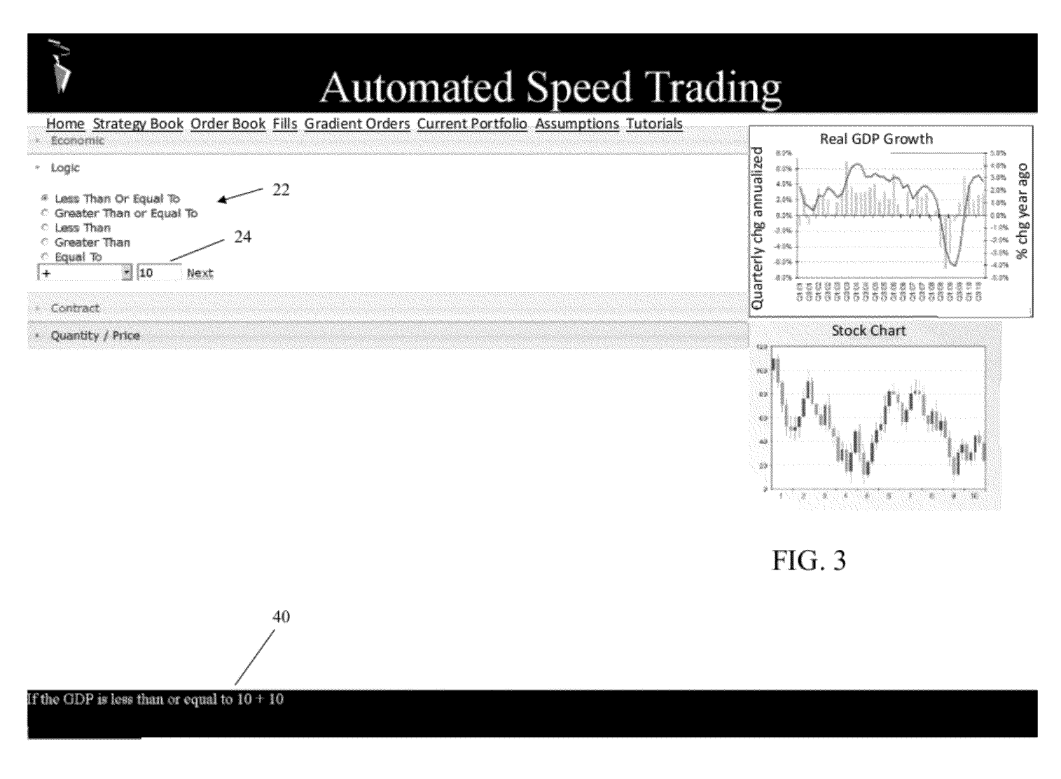

Once the user has selected a desired indicator 14, the system may display a previous value 18 and/or an estimated or expected value 20 for that indicator. The system then may provide the user with logic options 22, as seen in FIG. 3. For example, the user may be provided with the option to choose whether the indicator will be above or below the expected value. Further, the system may provide the user with discrete values or intervals such as: <5%, 5-10%, 10-15%, 15-20%, etc. Alternatively, the system may allow the user to enter a personalized discrete value or range 24. These values, at least in part, may reflect the user's aggressiveness, e.g., scheduling a trade if the indicator value deviates by 1% from an expected value 20 may be deemed more aggressive than scheduling a trade if the indicator value deviates 10% from that estimate.

Still further, instead of presenting the user with percentage values for comparison with the indicator, the system may allow the user to enter an absolute value or range of values for the indicator. This option may be particularly useful when the user seeks to set a lower bound below the expected value and an upper bound above the expected value.

Moreover, the system may accept an input from the user in the form of the user selecting a desired value from the graphical representation 16. For example, the user may use a mouse or other input device to place a pointer or cursor at a desired location on the graph. Clicking and holding a mouse button may project a line over the graph at that level that may be moved by dragging the mouse to allow the user to modify and verify the input value. Releasing the mouse button may set the value, and the system may transfer that value to the appropriate field and build it into the proposed transaction. Similar actions may be accomplished using a stylus or other device, e.g., the user's finger, in the case of touch-screen applications. In addition to using this process to select a value for the indicator, this process may be used to select a value such as price for the item to be traded, discussed below.

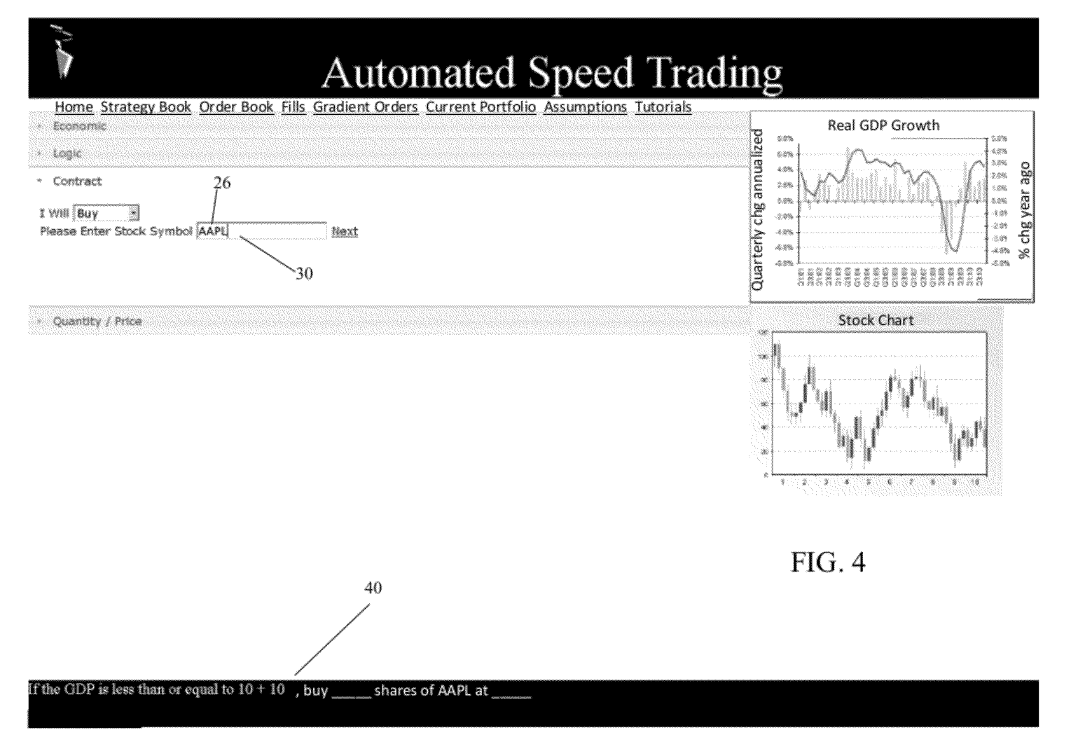

Turning to FIG. 4, in addition to selecting the triggering event, the system may prompt the user to selecting the item 26 to be traded. This may be a specific item such as shares of a stock or an amount of a commodity, but it also may be a share of a mutual fund, one of a predetermined number of contracts, or another type of investment device. Item 26 may be selected from a list 28 of potential options. Additionally or alternatively, the system may include an input 30 allowing the user to search for and/or select the item 26. For example, the user may enter the stock/ticker, mutual fund, index, or other symbol associated with the security. The system then may perform a database lookup to verify that the entered symbol matches a known security. Moreover, the system may prompt the user to specify the type 32 of trade to be made, e.g., buy vs. sell.

Once selected from the options presented to the user or if a match is found from the user input, the system also may present the user with a graphical representation 34 for the contract or item 26, e.g., historical data reflecting daily closing values with daily highs and lows, etc. As with indicator data, this information may be provided from an outside source, e.g., directly from one or more exchanges, and it may be delivered to data parser 6 for formatting before being sent to user interface 9.

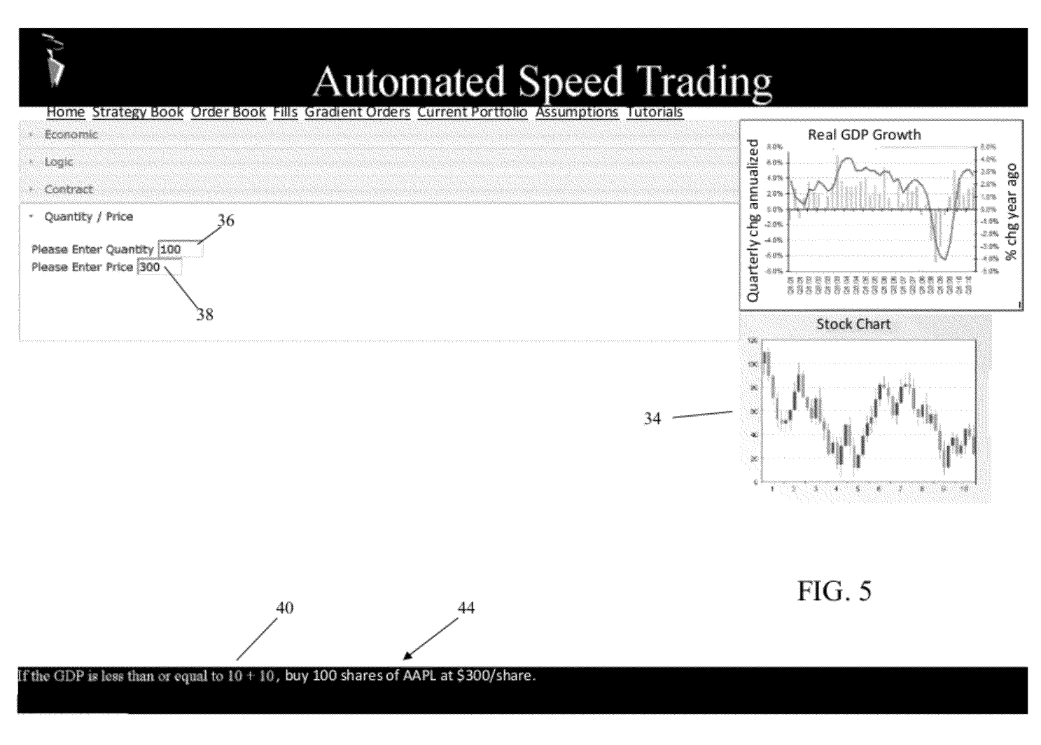

Turning to FIG. 5, the system then may allow the user to input a quantity 36 and desired per-unit price 38 of the item to be traded.

If the user selects “sell,” the system may cross-check both the item 26 to be traded and the selected quantity 36 against the user's portfolio 60 to verify that the user possesses a sufficient amount, e.g., number of shares, of item 26 to fulfill the transaction. If the selected quantity 36 exceeds the then-owned quantity, the system may display an error to the user or, alternatively, may reset the selected quantity 36 to the amount then-owned by the user.

Alternatively, the system may not execute this cross-check until the transaction 44 is triggered, at which point an insufficient number of shares may cause the logic to fail, canceling the transaction 44, or else the system may sell as many shares as the user possesses and then report that the remainder of the transaction cannot be fulfilled. This alternative may be preferred, because it keeps open the possibility that the user may acquire additional shares between when the transaction 44 is created and when it is triggered, which may allow the system to fill the transaction completely.

In still another alternative, system 10 may establish a subset of users that it may consider to be “accredited investors.” The system may provide these users with the ability to “sell short,” i.e., to sell a stock, bond, future, option, etc., without actually owning it. In this case, the system may not execute the cross-check.

As each option is presented to the user and the system receives the user's selections, the system may build and display to the user a summary 40 of the transaction to be carried out. Summary 40 describing the chosen logic may take the form of a textual sentence that is built as each selection is chosen. The progression of this summary 40 may be seen at the bottom of FIGS. 1-4, which show it growing with each selection. Transaction 44 may be governed by Boolean logic, such that each factor must be met to trigger execution of the transaction.

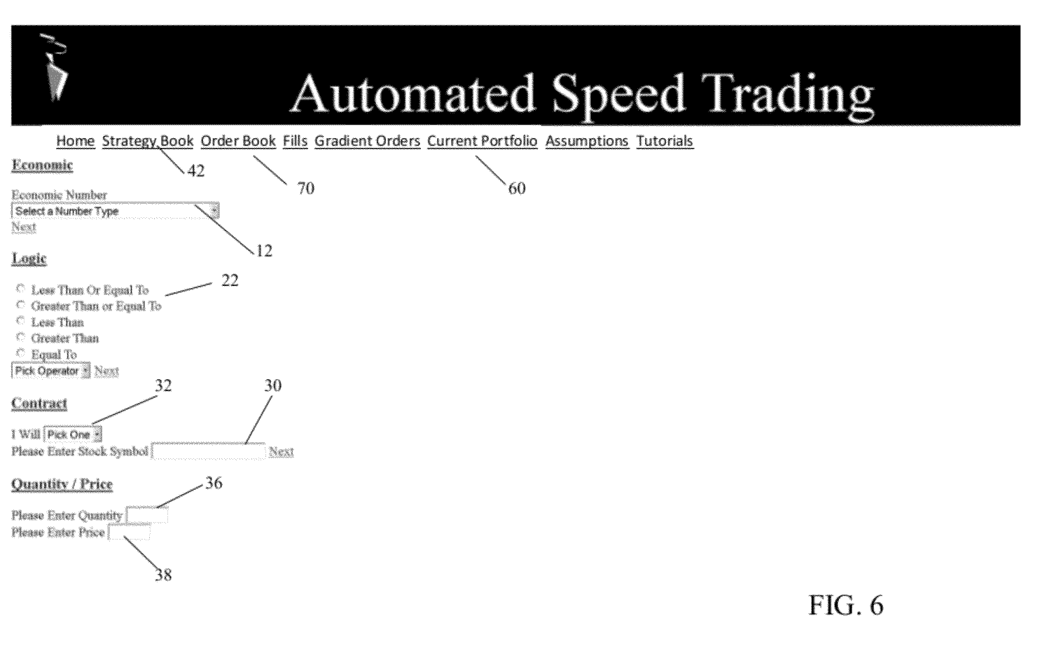

The embodiment shown in FIGS. 1-4 may display a plurality of discrete selection options to the user, which may allow the user to progress through the transaction in a step-by-step fashion. This may benefit more novice traders by requiring them to focus on and enter a smaller subset of necessary information at a time. In another embodiment, as seen in FIG. 6, each of these selection options may be displayed in a successive fashion, but on a single screen, so that the user may be presented with substantially all of the fields requiring input at the same time.

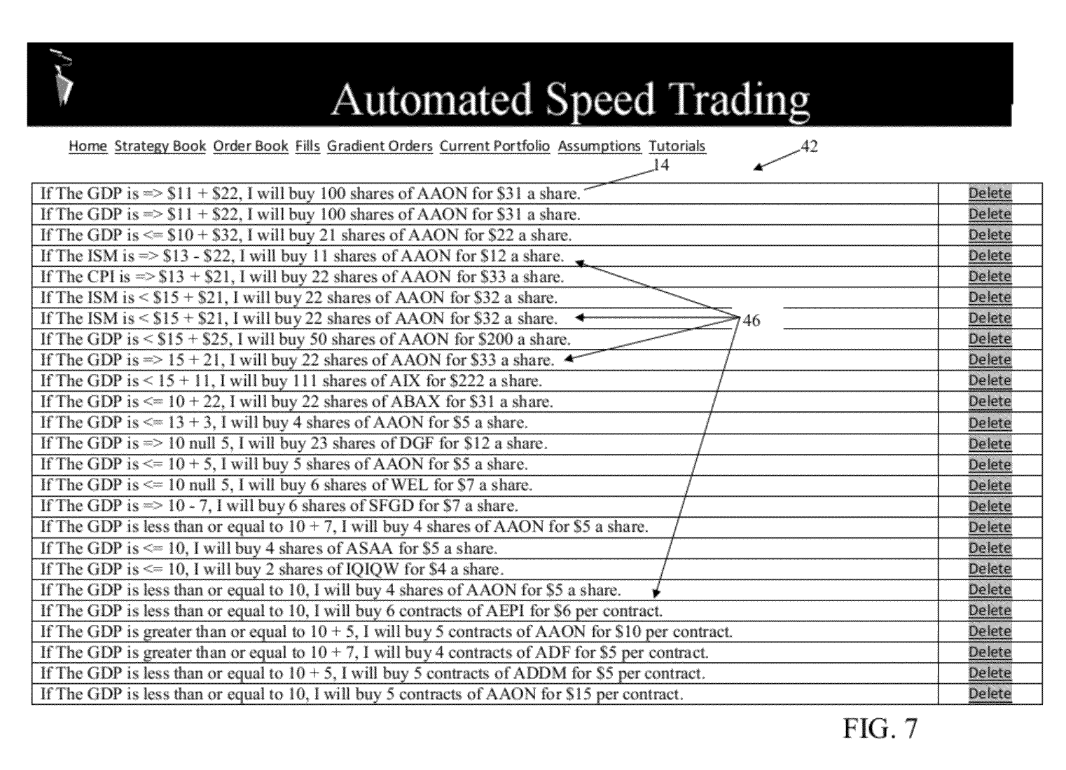

Turning to FIG. 7, once each transaction 44 is created, it may be placed into a strategy book 42 along with other previously-created transactions 46. Each transaction may be represented in a form substantially identical to the summary 40 that was presented to the user while the transaction was being built. Separate transactions may refer to the same indicator 14, logic options 22, item 26 to be traded, buy/sell option 32, etc. In this way, a user may establish several strategies, e.g., he may want to buy shares of stock X if GDP surpasses the estimated value by 5% but sell stock X if GDP stays even, or he may want to buy shares of stock X if GDP surpasses the estimated value by 5% but sell stock Y in the same instance.

Strategy book 42 may be a list of strategies or transactions 44 awaiting their trigger events 14. Some transactions may be established substantially in perpetuity, or at least until modified or canceled by the user. These transactions may relate to infrequently or randomly occurring events, to events that the user may believe have larger implications than other events, or to any events to which the user may wish to respond over time. For example, the user may wish to sell a certain stock if a certain country's sovereign credit rating or a certain company's credit rating drops to BB. It is possible that this trigger event 14 may never occur and, as such, the scheduled transaction may remain, unexecuted, in strategy book 42.

Transactions in strategy book 42 may include those that have been scheduled but that have not executed for one or more reasons. For example, indicator 14 may not have been updated or released yet, obviating any need to determine whether to execute the transaction. Alternatively, one of the other logical conditions in the transaction summary 40 may not have been met, so the transactions may not be triggered, e.g., the user may want to buy 100 shares of stock X if GDP is 5% or more above the expected value 20, but if it is only 2% higher, the order is not placed.

While some indicators 14 may represent substantially one-time occurrences, other indicators often are updated periodically, e.g., daily, weekly, quarterly, etc. Thus, it may be possible for the logic of a transaction 44 to be not met when the indicator is first updated after transaction 44 was created but then is met at a later update. The system may retain these first-time-failed transactions in strategy book 42 until their conditions are met. Preferably, however, if an indicator 14 is updated and the logic behind a transaction 44 fails for one or more reasons, the transaction simply may not occur, and the user may remove that transaction from the strategy book or the system may delete it automatically.

Once transaction 44 is formed, strategy engine 8 may review data entered by the user and data received from data parser 6 to determine whether to execute a trade. This procedure may occur on a periodic basis, e.g., at predetermined time intervals. Preferably, however, whenever data parser receives data regarding any indicator, it may send that data to strategy engine 8. Strategy engine 8 then may cross-check pending transactions to determine whether the user relies upon that indicator in any of the pending transactions 44. Thus, transactions may be executed rapidly after indicator 14 is updated (provided that the remaining transaction criteria also are met).

If all logic conditions are met for a transaction 44, that transaction may be sent to order book 70. From there, market conditions may dictate if the order is filled or not. Assume the market can fill the order, system 10 may execute the transaction 44 and fill the order, e.g., by sending the order to the appropriate exchange. Filled orders may be aggregated and displayed to the user, preferably in a single location, e.g., on a single display screen. In this way, the user quickly may be able to see a history of all transactions that have occurred. Alternatively, if market conditions prevent an order from being filled, that order may remain in order book 70, preferably until such time as it can be filled.

Filling of an order may occur in one or more ways. For example, orders may be sent directly to the appropriate exchange. Alternatively, orders may be transmitted to a third party, which may communicate with the exchanges to place the orders. Once communication with the exchange is established, the exchange may match buys and sells to determine whether the order may be filled and, if so, it may fill the order. During this process, system 10 may ping the exchange or the third party application and seek confirmation that the user's order has been filled. The exchange and/or the third party application may include an API, preferably an open API, which may facilitate communication with system 10.

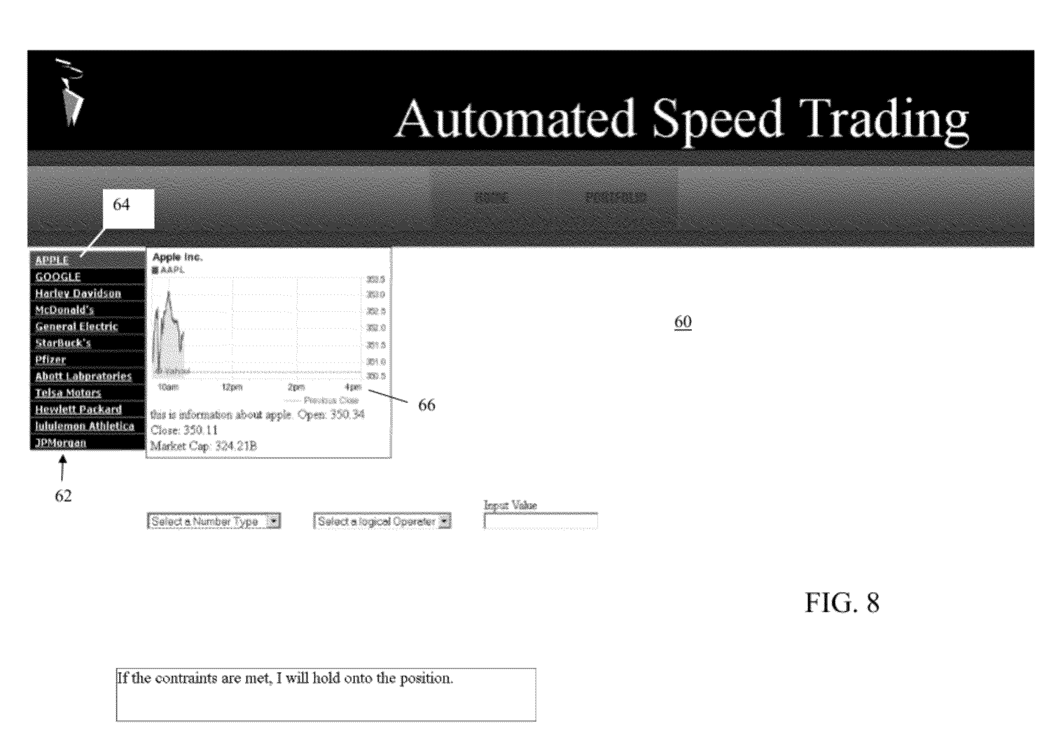

As seen in FIG. 8, system 10 further may include an option to display a user's portfolio 60, which may comprise a list or other display 62 of each item 64, e.g., stock or mutual fund, then-owned by the user. At the outset, the system may prompt the user to enter all stocks, bonds, mutual funds, etc. then-owned by the user or it may import this information from another location, which may include a third party financial analysis or management product. Portfolio 60 may provide additional information to the user regarding the user's investments, such as earnings reports, which may be provided periodically, e.g., monthly, quarterly, yearly, at some interval chosen by the user or some other predetermined interval. With this additional information, the system may assist the user in creating an exit strategy. For example, the user may be able to hold and/or dispose of investments according to constraints such as EPS, P/E, EBITDA, or other GAPP or non-GAAP metrics, and system 10 may display these metrics to the user in portfolio 60 or at another place.

When viewing portfolio 60, the user may select one of the items 64, and the system may provide the user with historical information 66 regarding that item, preferably in a graph-based or other visual manner. Historical information 66 may be similar to historical information 34 displayed to the user in FIG. 4, but historical information 66 may include other information, such as the current day's open and/or close values, a substantially real-time display in variations in cost, and other data the user may value in evaluating the item 64.

Staying with FIG. 8, system 10 may enable the user to schedule transactions 44 directly from portfolio 60. In this option, the system may assume that the stock or other item being viewed is the subject of the proposed transaction and, therefore, may not prompt the user to identify the desired item. In other aspects, however, the system may provide the user with substantially the same prompts described above. For example, the system may prompt the user to identify the trigger indicator 14, the logical comparators 22, whether to buy or sell 32 and the desired price 38 per share or unit. As with transactions 44 created in other fashions, once the transaction is prepared, it may be delivered to strategy book 42 to await updating of indicator 14 to determine whether transaction 44 is filled.

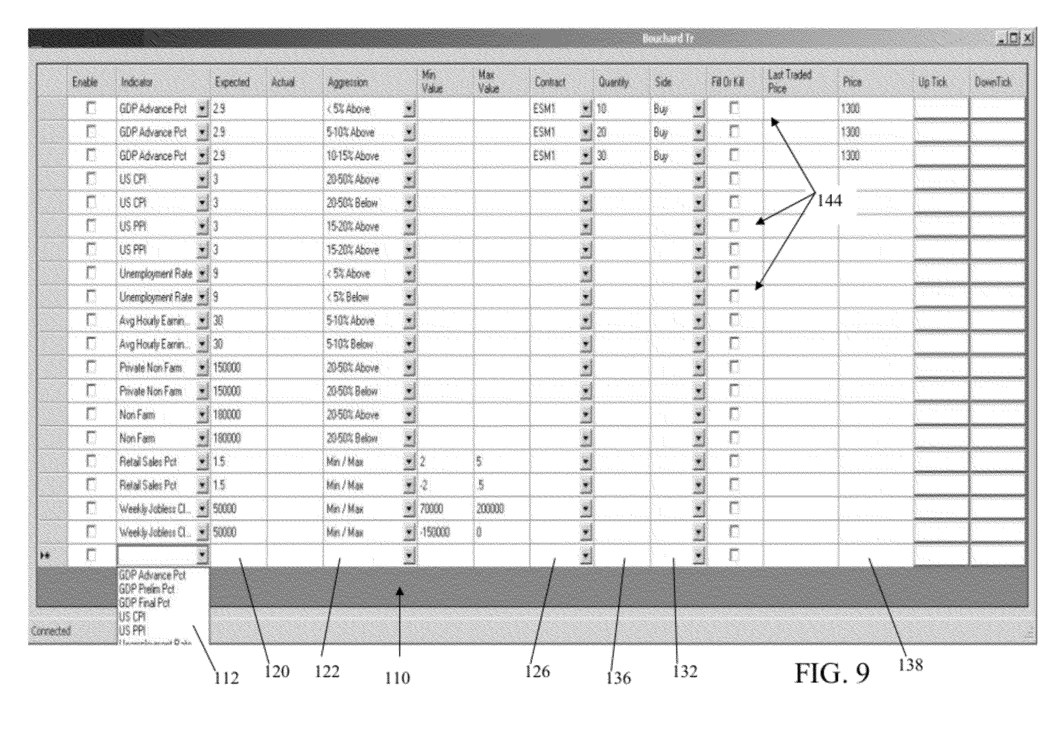

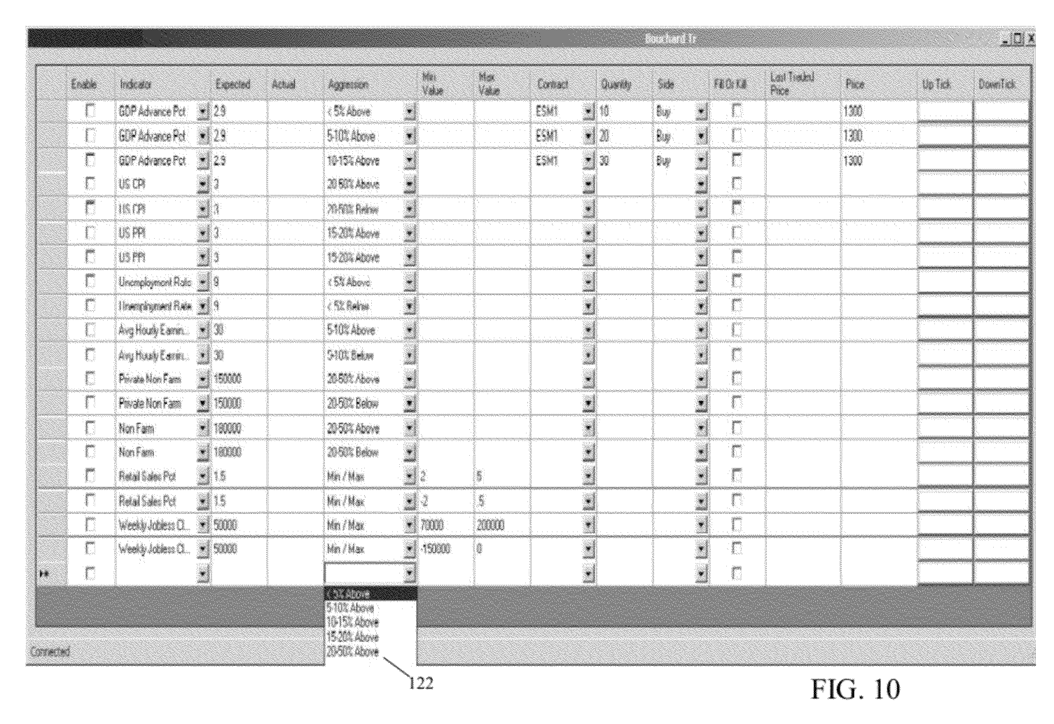

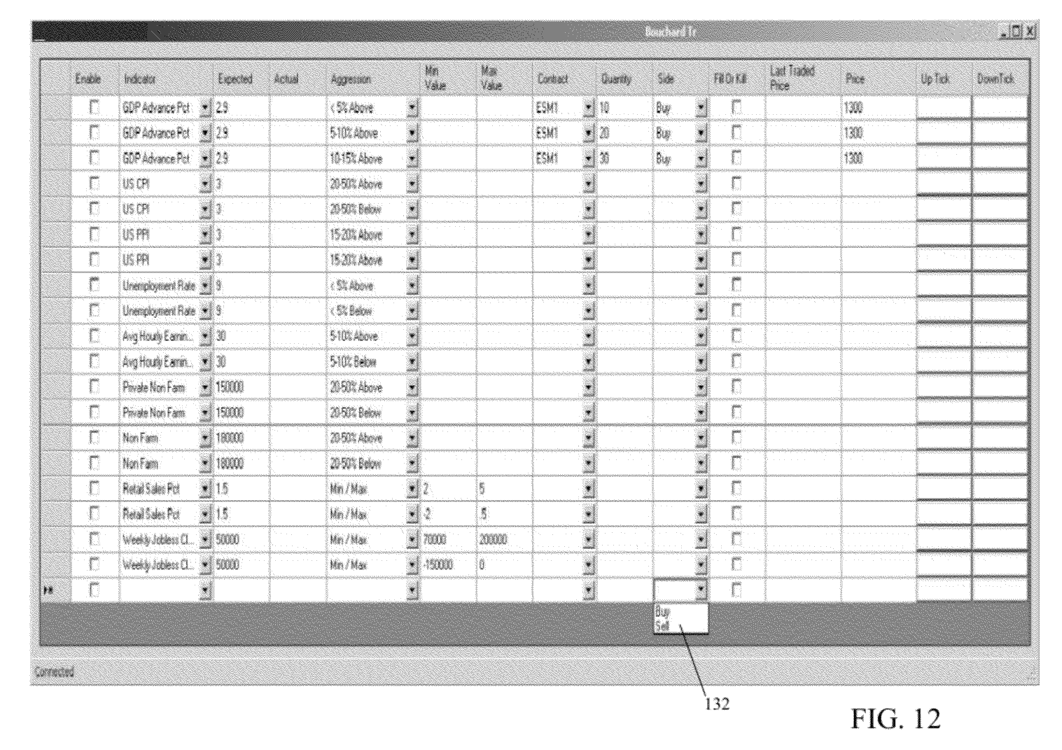

Turning to FIGS. 9-12, a second embodiment of system 110 is presented. This embodiment is similar to the one shown in FIG. 6, in that the system presents the user with substantially all elements necessary to build a transaction 144 one the same display screen at the same time. Additionally, in this embodiment, the user may be able to build transactions 144 but then decide whether to enable them or not, i.e., whether to send them to a strategy book to be filled if their logic parameters are met. System 11 may retain these transactions 144, whether enabled or not, for future use so that user may not need to re-build transactions every time indicator 114 is scheduled to update.

In this embodiment, system 110 may present other options to the user, such as the ability to select whether the transaction should be “fill or kill,” “immediate or cancel,” “good until canceled,” or some other method of designating the period of time for completing an order. Other options presented to the user may include, e.g., “one time event” or “until canceled strategy,” or UCS. As discussed above, transactions set up with one time event strategies either will be triggered and sent for filling or will not be triggered and subsequently deleted, removed from the strategy book, etc. Conversely, transactions set up with UCS designations may remain pending until sent for filling or manually removed or edited by the user. These may be transactions having triggering events of a more random nature, such as changes in sovereign credit ratings.

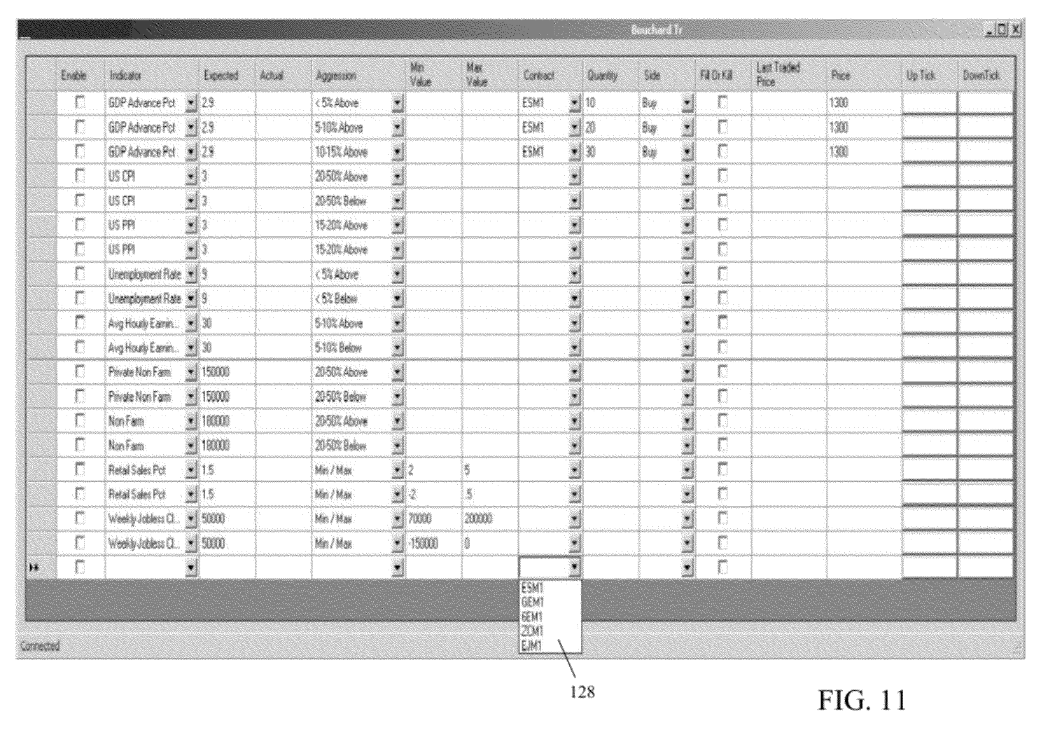

It can be seen in this embodiment that item 126 to be traded may be something other than traditional stocks or bonds, although this variation is not limited to this second embodiment. As seen in FIG. 11, the symbol representing each contract may include multiple pieces of information about that item 126. For example, the first portion of each symbol, “ES,” “GE,” “6E,” “ZC,” “EJ,” etc., may represent the product being traded and the second portion, “M1,” e.g., may represent a time period covered by the contract.

Additionally, system 110 may enable the user to change the desired price for the transaction 144 incrementally, e.g., via the “up tick” and “down tick” buttons. Each incremental change may correspond to a predetermined amount, which in one case may be a minimum price increment for that contract, e.g., “ticks,” “half ticks,” “cents,” etc.

In still another embodiment, the system may be used to place limit orders, which may be filled partially and are only filled completely if the user is able to obtain enough contracts at the desired price or better. For “buy” transactions, this means that the full number of contracts may be purchased only if the user can obtain those contracts at or below the desired price. Similarly, for “sell” transactions, the full number of contracts may be sold only if the user can dispose of those contracts at or above the desired price. While limit orders do not guarantee that the system will be able to satisfy the user's contract desires, it also is possible that the orders may be filled at a better price, in whole or on average, than what the user requests. These orders may be separate from the transactions 44 described above, or they may be considered a subset of those transactions.

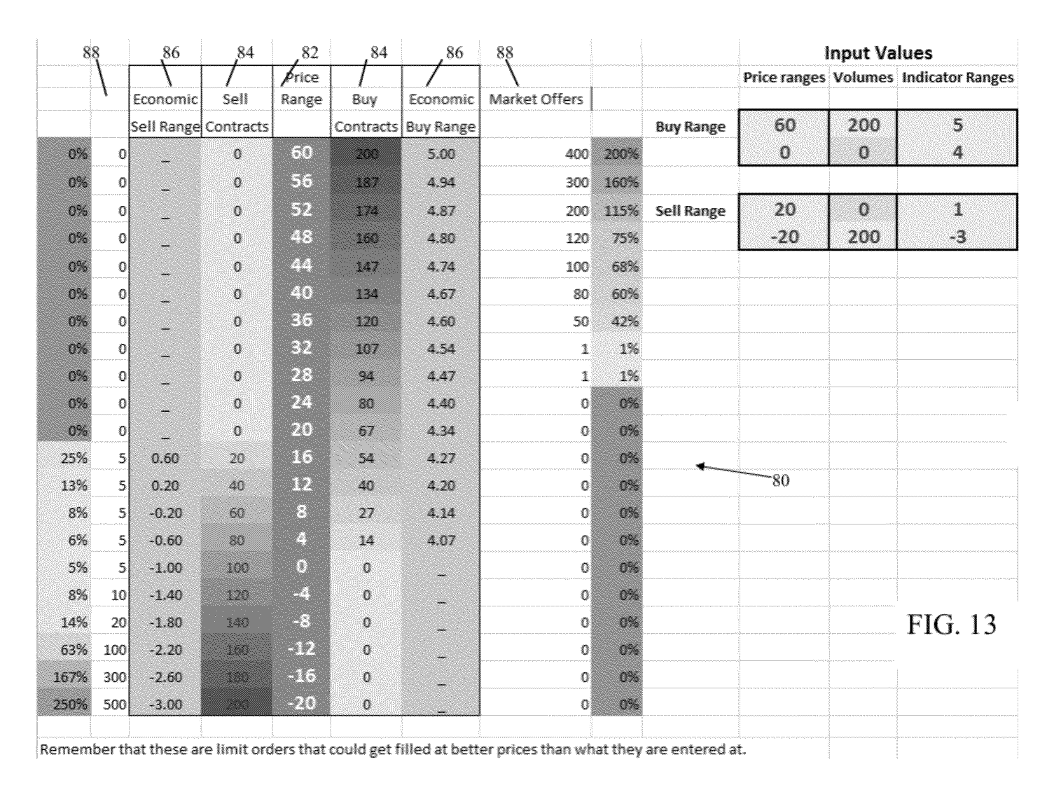

Turning now to FIG. 13, user interface 9 may include a gradient display 80 to help the user evaluate current conditions for a desired contract. Gradient display 80 may provide the user with substantially real-time information regarding the number of contracts available for purchase or desired for sale in the market and the respective prices for those contracts. This information may be presented in the context of the potential number of contracts that the user may wish to buy or sell and may be accomplished by providing a price range column 82 incrementally divided into price values.

Price values may represent absolute or actual price values. Alternatively, they may reflect a deviation from some base value, e.g., the current market price or the price previously paid by the user. As such, it may be possible to have negative price values, since this simply may indicate a price lower than the base value.

The upper and lower values for the price range may be the highest and lowest values at which the contract is being traded or has been traded within a certain period of time. Alternatively, the system may receive inputs from the user for these values, e.g., the minimum price for which the user is willing to sell a contract and the maximum price the user is willing to pay to buy a contract, which values may create a substantially narrower range than in the former case.

In addition, gradient display 80 may allow the user to enter upper and lower bounds for one or both of the potential number of contracts the user may wish to buy or sell, as well as upper and lower bounds for the price to which the user may agree. Having received these upper and lower bounds, gradient display 80 may populate columns 84 for these buy and/or sell contracts. Entries in these columns may be calculated based on the values received from the user, e.g., they may be averaged, such as via arithmetic mean, from the lower bound to the upper bound for the number of contracts over the price range entered by the user.

Similarly, gradient display 80 may calculate and display indicator ranges 86, e.g., buy ranges and sell ranges. If indicator 14 is an economic indicator, these may be referred to as economic ranges, as seen in FIG. 13, although they still may be considered indicator ranges. As discussed in the embodiments described above, the user may set a value or range 24 relating to the expected value 20 of an indicator 14, and upper and lower bounds for each indicator range 86 may correspond with this range 24. In other words, values within the indicator range 86 may trigger a trade.

In one embodiment, the user may enter only a single value. Preferably, however, the system may prompt the user to provide upper and lower bounds to create an acceptable range 86. This may insulate the user against inadvertent trades, particularly those caused by third parties such as the indicator data providers. For example, the user may establish a transaction that buys a certain number of shares of a contract if GDP exceeds estimates by 3-6%. Alternatively, the user may create a transaction in which the shares are purchased if GDP exceeds estimates by 3% or more. If GDP exceeds estimates by 2.0% and the data provider enters this amount, in both cases, the transaction should not be filled. However, if the data provider inadvertently enters this amount as 20%, the transaction still would not be executed in the former case, but it would be executed in the latter case.

Additionally, inputs into gradient scale 80 may be executed by selecting the inputs from a chart or other graphical display pertaining to the relevant indicator 14 or item 26 to be traded. For example, the user may use a mouse or other cursor controlling device to select a value or range of values. In one embodiment, clicking/selecting a value may cause that value to be imported into gradient display 80. In another embodiment, the user may select a desired value or range and then drag that value or range over to gradient display 80.

Gradient display 80 also may display to the user the number of available market offers 88, both for purchase and for sale, at each price range. These values preferably may be received substantially in real time to reflect current market conditions as accurately as possible, which may provide the user with a more accurate picture of the number of contracts available. There may be overlap in the buy and sell price ranges and, as such, both buy contracts and sell contracts may be available for one or more price range values.

Alongside available market offers 88, gradient display 80 may provide the user with a visual indicator 90 of the likelihood of having the desired number of contracts fulfilled at each price range value. Indicator may include a percentage indicator 92 reflecting how many of the desired contracts are available at that range. This percentage indicator 92 may be based solely on the number of contracts available at that price as compared to the number of desired contracts. Alternatively, percentage indicator 92 may take into account contracts that are available at a better price. For example, if the user seeks to buy 100 contracts at a price range of 50 or better, and if 5 contracts are available at a price of 20 and 10 are available at a price of 25, in the first case, the percentage indicator 92 at a price of 25 may be 10% (10/100). In the second case, the percentage indicator 92 at a price of 25 may be 15% (5+10/100).

Additionally, visual indicator 92 may include a color-coded overlay, such as a red-yellow-green progression, whereby price values corresponding to no available contracts may have a red indicator. Similarly, price values corresponding to some predetermined threshold value, e.g., about 25%, may have a yellow indicator, and price values above that threshold value may have a green indicator. Further, within one or both of the yellow and green ranges, the ranges may be divided into additional, progressive shades of yellow and green.

Gradient display 80 may include indicators prompting the user to input upper and lower bounds for price 82, volume 84, and indicator 86 values for either or both of “buy” transactions and “sell” transactions. As the user varies any of these parameters, the display may adjust accordingly. For example, inputting a larger maximum price in the buy range may cause a recalculation and, therefore, a modification of the values in the rest of the price range. Similarly, modifying the number of contracts to buy and/or sell may alter visual indicator 92, which may provide the user with an easy, quick way to visually determine the likelihood of having the limit order filled completely. Additionally, while system 10 may enable the user to enter values for both purchase and sell, it may not be necessary for the user to provide values for both order types. Thus, a user seeking only to establish purchase transactions related to a certain contract may not have to provide sell range values.

Gradient display 80 may be linked to the rest of system 10, such that selecting a volume and/or price range may populate quantity 36 and price fields 38 in building a transaction 44.

System 10 preferably is intended for a retail market, e.g., an average consumer that wishes to be more hands-on in their investing but that does not have access to all of the tools available to a commercial trader. As such, system 10 preferably may be accessible via a secure website such as one using HTTPS protocol. This may consume fewer of the user's system resources and not require the user to download and install software on the user's machine. Additionally, it may provide for portability, in that the user may access his or her account from any computer with an Internet connection, as opposed to the local device on which software is installed.

While system 10 preferably is presented to the user as a web-based application, it also may be implemented via software locally stored on the user's Internet-enabled device. In either case, data transmission to and from the user is through a secure connection such as HTTPS and/or is encrypted with protocols such as SSL or TLS or other public key encryptions. Transmissions from the system to the exchange or third party that executes trades may occur in a similar manner or also may occur via a dedicated hard line.

The system should be configured to comply with government-established standards, such as CFTC trading rules. Thus, the system may provide a record of each transaction executed on behalf of the users, recording all data necessary to comply with those standards. Additionally, users may be required to fill out compliance forms or provide the system with sufficient information to verify that they are and will be compliant with all applicable rules. Similarly, although system 10 may enable the user to schedule short sales, such sales may be accepted only from users deemed to be accredited investors within a framework determined by the system or under an accepted set of standards.

While the foregoing written description of the invention enables one of ordinary skill to make and use what is considered presently to be the best mode thereof, those of ordinary skill will understand and appreciate the existence of variations, combinations, and equivalents of the specific exemplary embodiment and method herein. The invention should therefore not be limited by the above described embodiment and method, but by all embodiments and methods within the scope and spirit of the invention as claimed.

What is claimed is:

1. A computer-implemented method for creating event-driven financial transactions, comprising:
prompting a user to select an indicator from among a plurality of possible indicators;
receiving an indicator selection;
receiving a comparative function relating to an estimated value of said selected indicator;
prompting said user to select an item to be traded from among a plurality of possible items;
receiving an item selection;
receiving inputs relating to price and volume variables for said selected item;
generating a pending transaction, and
displaying said pending transaction to said user in a form readable by said user.

2. A method according to claim 1, further comprising:
displaying historical information relating to said selected indicator.

3. A method according to claim 1, wherein said user selections are received via an Internet website.

4. A method according to claim 1, wherein said displaying step comprises:
building said pending transaction progressively as more elements of said transaction are received; and
displaying said pending transaction as it is built.

5. A method according to claim 1, further comprising:
receiving an updated value for said selected indicator;
cross-checking said updated value with said comparative function to determine whether to execute said transaction; and
transmitting an executed transaction to an exchange to be filled.

6. A method according to claim 5, wherein said transmitting step comprises transmitting said executed transaction to a third party or directly to said exchange.

7. A method according to claim 1, wherein said form comprises a textual summary.

8. A method according to claim 1, wherein said indicator comprises an economic indicator.

9. A method according to claim 1, wherein said indicator comprises a non-economic indicator.

10. A method according to claim 1, wherein, if said transaction is a sale, said method further comprises:
cross-checking a user's inventory of said item against said volume variables; and
verifying that said user possesses a sufficient quantity of said item.

11. A method according to claim 1, said method enabling a user to schedule short sale transactions.

12. A computer implemented method for creating and executing event-driven financial transactions, comprising:
receiving information from at least one source pertaining to a plurality of indicators;
converting said information into a form displayable to a user;
receiving input variables from said user;
generating a pending transaction;
receiving updated information pertaining to a selected indicator;
evaluating said pending transaction in view of said updated information; and
transmitting said pending transaction to be filled if all of said input variables are met.

13. A method according to claim 12, further comprising:
compiling a plurality of pending transactions in a single location viewable by said user.

14. A method according to claim 12, further comprising:
displaying historical information relating at least one of an indicator and an item to be traded.

15. A method according to claim 14, wherein said historical information is presented to said user in graphical form, wherein said graphical presentation of said historical information provides for selections by said user, and further wherein said step of receiving input variables comprises receiving said user selections.

16. A method according to claim 12, further comprising:
providing a gradient display to said user, said gradient display comprising incremental information pertaining to said input variables.

17. A method according to claim 16, wherein said gradient display provides substantially real-time analysis of a number of available units of a selected item.

18. A method according to claim 16, wherein said gradient display provides information relating to both purchase and sale transactions.

19. A method according to claim 16, further comprising:
populating fields within said gradient display with said input variables, wherein said input variables are received via manual input or via selection from a graphical display.

20. A method according to claim 16, wherein one of said input variables comprises an input deviation from an expected value of said selected indicator, wherein said gradient display includes fields populated by deviations from said expected value, and further wherein said input deviation comprises an upper or lower bound for said fields.
